(19) United States
(12) Patent Application Publication
(10) Pub. No.: US 2026/0347650 A1
(43) Pub. Date: Nov. 5, 2026

(54) COATING COMPOSITION, METHOD FOR PRODUCING COATED ARTICLE, COATED ARTICLE, AND SILSESQUIOXANE DERIVATIVE

(71) Applicants: Japan Aerospace Exploration Agency, Tokyo (JP); The University of Osaka, Osaka (JP)

(72) Inventors: Kazuki YUKUMATSU, Chofu-shi, Tokyo (JP); Aki GOTO, Chofu-shi, Tokyo (JP); Yugo KIMOTO, Chofu-shi, Tokyo (JP); Yutaka IE, Suita-shi, Osaka (JP); Soichi YOKOYAMA, Suita-shi, Osaka (JP)

(21) Appl. No.: 19/486,396

(22) PCT Filed: Apr. 4, 2024
(86) PCT No.: PCT/JP2024/013881

§ 371 Date: Nov. 21, 2025

(30) Foreign Application Priority Data
May 31, 2023 (JP) 2023-089767

(51) Int. Cl. C09D 183/04; B64G 1/22; B64G 1/58; C08G 77/04

(52) U.S. Cl. CPC C09D 183/04; B64G 1/226; B64G 1/58; C08G 77/045

(57) ABSTRACT

Provided are: a coating composition which has enhanced coatability and solubility in solvents and contains POSS with alkyl groups introduced; a method for producing a coated article using the coating composition; and a produced coated article. The present invention relates to a coating composition containing a silsesquioxane derivative which has a silsesquioxane skeleton having a polyhedral structure and in which a plurality of alkyl groups having different numbers of carbon atoms are bonded to silicon atoms. The coating composition can be applied to a substrate to produce a coated article. This produced coated article has a substrate and a coating, formed on the surface of the substrate, that contains a silsesquioxane derivative which has a silsesquioxane skeleton having a polyhedral structure and in which a plurality of alkyl groups having different numbers of carbon atoms are bonded to silicon atoms.

### TECHNICAL FIELD

The present invention relates to a coating composition, a method for producing a coated article, a coated article, and a silsesquioxane derivative.

### BACKGROUND ART

Spacecraft such as an artificial satellite, a space shuttle, and a space station fly in a low Earth orbit environment at an altitude of 100 km to 700 km. It is known that the low Earth orbit environment contains a large amount of atomic oxygen (AO), which is formed when atmospheric oxygen molecules are dissociated into atoms by ultraviolet rays from the sun. It is also known that a multi-layer insulation (MLI) used for thermal insulation of spacecraft is eroded and damaged by collision with AO.

A polyimide film having excellent heat resistance, radiation resistance, and ultraviolet resistance is used as the outermost layer of the MLI. In order to prevent erosion of the polyimide film by AO (in order to improve AO resistance), a method of introducing a polysiloxane structure into a polyimide resin in the polyimide film has been studied (PTL 1).

The polyimide resin having a polysiloxane structure as described in PTL 1 can improve AO resistance of the film, but is not practical because the resin structure is complicated and requires a multi-stage synthesis. As a method of more easily improving AO resistance, a method of forming an aluminum-containing film on the surface of a polyimide film (PTL 2) or a method of forming a cured film of polysiloxane into which a curable functional group such as an epoxy group or an acryloyl group is introduced (PTL 3 and NPL 1) has also been investigated.

It has been reported that the cured film of polysiloxane into which a curable functional group is introduced is physically damaged by collision with AO (NPL 2).

### CITATION LIST

### Patent Literature

### PTL 1

Japanese Patent Application Laid-Open No. 2003-113264

### PTL 2

Japanese Patent Application Laid-Open No. 2004-225006

### PTL 3

Japanese Patent Application Laid-Open No. 2011-042755

### Non-Patent Literature

### NPL 1

Kimoto et al., “Development of space-qualified photocurable-silsesquioxane-based polyimide films”, Journal of Spacecraft and Rockets, 53.6 (2016), pp. 1028-1034

### NPL 2

Goto et al., “Property changes in materials due to atomic oxygen in the low Earth orbit”, CEAS Space Journal, 13.3 (2021), pp. 415-432

### SUMMARY OF INVENTION

### Technical Problem

It is expected that providing a coating having AO resistance as described in PTL 2, PTL 3, and NPL 1 can improve the AO resistance of a polyimide film without requiring a complicated manufacturing process. In addition, it is expected that such a coating can improve the AO resistance of not only the polyimide film but also other members. However, a metal coating as described in PTL 2 is more likely to be cracked due to a collision with AO, and cannot prevent AO from penetrating through the cracks and eroding the polyimide film. In addition, curable polysiloxanes described in PTL 3 and NPL 1 require photocuring after the application, which makes the formation of coatings time-consuming, and as described in NPL 2, the AO resistance cannot be sufficiently improved.

Meanwhile, the present inventors found that by applying a silsesquioxane derivative—from a cage-type silsesquioxane (polyhedral oligomeric silsesquioxane: POSS. Hereinafter, also simply referred to as “POSS”) into which an octyl group is introduced—is applied to a polyimide film or a silicon substrate, a coating with high AO resistance can be formed. However, this silsesquioxane derivative has low solubility in a solvent, and even when the silsesquioxane derivative is dissolved, the coatability thereof on a polyimide film, silicon, or the like is poor.

POSS is a compound that is expected to be used in a variety of applications. Therefore, when the solubility of POSS, into which an alkyl group is introduced, in a solvent and the coatability of POSS can be increased, it is expected that the development of POSS in various applications other than the AO resistance coating would become easy.

The present invention has been made in view of the above problems, and an object of the present invention is to provide a coating composition containing POSS, into which an alkyl group is introduced, with improved solubility in a solvent and coatability, a method for producing a coated article using the coating composition, a coated article which is produced by the method, and the POSS (silsesquioxane derivative).

### Solution to Problem

One aspect of the present invention for achieving the above object relates to the following coating compositions [1] to [3].
[1] A coating composition, including:
   a silsesquioxane derivative having a silsesquioxane skeleton with a polyhedral structure and having a plurality of alkyl groups having different carbon numbers, the plurality of alkyl groups each being bonded to a silicon atom.
[2] The coating composition according to [1], in which the coating composition is a coating composition of a spacecraft.
[3] The coating composition according to [1] or [2], in which a concentration of a polymerizable compound and a resin in the coating composition is 0% by mass or more and 10% by mass or less based on a total mass of solids in the coating composition.

One aspect of the present invention for achieving the above object relates to the following method for producing a coated article [4].
[4] A method for producing a coated article, the method including:
   applying the coating composition according to any one of [1] to [3] to a base material.

One aspect of the present invention for achieving the above object relates to the following coated articles [5] and [6].
[5] A coated article, including:
   a base material; and
   a coating formed on a surface of the base material, the coating containing a silsesquioxane derivative that has a silsesquioxane skeleton with a polyhedral structure and has a plurality of alkyl groups having different carbon numbers, the plurality of alkyl groups each being bonded to a silicon atom.
[6] The coated article according to [5], in which the coated article is a member disposed on a surface of a spacecraft, the surface being exposed to an outside of a body of the spacecraft.

One aspect of the present invention for achieving the above object relates to the following silsesquioxane derivative [7].
[7] A silsesquioxane derivative, including:
   a silsesquioxane skeleton with a polyhedral structure; and
   a plurality of alkyl groups having different carbon numbers, the plurality of alkyl groups each being bonded to a silicon atom.

### Advantageous Effects of Invention

The present invention can provide a coating composition containing POSS, into which an alkyl group is introduced, with improved solubility in a solvent and improved coatability, a method for producing a coated article using the coating composition, a coated article which is produced by the method, and the POSS (silsesquioxane derivative).

### DESCRIPTION OF EMBODIMENTS

An embodiment of the present invention relates to a coating composition containing POSS into which an alkyl group is introduced.

The coating composition contains a silsesquioxane derivative having a silsesquioxane skeleton with a polyhedral structure, and in the silsesquioxane derivative, a plurality of alkyl groups having different carbon numbers (i.e., alkyl groups whose carbon numbers are different from each other) are each bonded to a silicon atom.

### [Silsesquioxane Derivative]

The silsesquioxane derivative may have any structure as long as it has a silsesquioxane skeleton with a polyhedral structure, and in the silsesquioxane derivative, a plurality of alkyl groups having different carbon numbers are each bonded to a silicon atom.

The type of silsesquioxane skeleton having a polyhedral structure is not limited, and may be T₈ (general formula (1)) in which the number of Si atoms located at the vertices of the polyhedron is 8, may be T₁₀ in which the number of Si atoms located at the vertices of the polyhedron is 10, or may be T₁₂ in which the number of Si atoms located at the vertices of the polyhedron is 12.

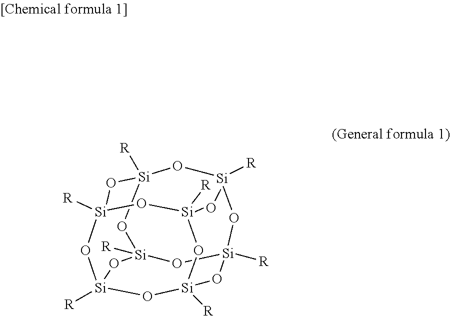

In general formula (1), R represents an alkyl group having 1 or more and 32 or less carbon atoms. It should be noted that, in the present embodiment, R's include a plurality of alkyl groups having different numbers of carbon atoms.

As in the description for general formula (1), in the silsesquioxane derivative, a plurality of alkyl groups having different carbon numbers are each bonded to a silicon atom. It is considered that the silsesquioxane derivative has both high AO resistance due to POSS to which alkyl groups are bonded and satisfactory solubility in a solvent due to weakened intermolecular interaction. In addition, the silsesquioxane derivative provides high outgassing properties of a film formed from the silsesquioxane derivative. Specifically, the silsesquioxane derivative emits a low amount of gaseous substance (low TML in outgassing property test), the emitted gaseous substance is less likely to adhere to other materials (low CVCM in outgassing property test), and the silsesquioxane derivative emits little outgassing other than water vapor (low RML in outgassing property test). Therefore, the silsesquioxane derivative can be suitably used for space applications.

All of the plurality of alkyl groups may be chain-like alkyl groups, which are either linear or branched, or may be alkyl groups having an alicyclic structure, or the plurality of alkyl groups may be a combination of a chain-like alkyl group and an alkyl group having an alicyclic structure. In addition, the plurality of alkyl groups may be composed of two types of alkyl groups having different carbon numbers, or may be composed of three or more types of alkyl groups having different carbon numbers. The upper limit of the number of types of alkyl groups having different carbon numbers can be set to 12 or less, 10 or less, or 8 or less depending on the type of silsesquioxane skeleton. From the viewpoint of providing satisfactory solubility in a solvent, it is preferable that at least one of the plurality of alkyl groups is linear. Of the plurality of alkyl groups, two or more alkyl groups may be linear or all of the alkyl groups may be linear.

The plurality of alkyl groups are not particularly limited as long as the number of carbon atoms is 1 or more and 32 or less, but it is preferable to include an alkyl group having 2 or more and 30 or less carbon atoms, it is more preferable to include an alkyl group having 3 or more and 25 or less carbon atoms, it is still more preferable to include an alkyl group having 4 or more and 22 or less carbon atoms, and it is particularly preferable to include an alkyl group having 5 or more and 20 or less carbon atoms. In this case, it is sufficient that at least one of the plurality of alkyl groups has a number of carbon atoms in the above-described preferred range, but two or more alkyl groups may have a number of carbon atoms in the above-described preferred range, or all of the alkyl groups may have a number of carbon atoms in the above-described preferred range.

In addition, the difference between the numbers of carbon atoms of the plurality of alkyl groups, that is, the difference between the number of carbon atoms of the alkyl group having the largest number of carbon atoms and the number of carbon atoms of the alkyl group having the smallest number of carbon atoms is preferably 2 or more and 32 or less, more preferably 4 or more and 20 or less, and still more preferably 4 or more and 8 or less.

In addition, the molar ratio (AR2/AR1) between the alkyl group (AR1) having the largest number of alkyl groups contained in the silsesquioxane derivative and the alkyl group (AR2) having the second largest number of alkyl groups contained in the silsesquioxane derivative is preferably 0.1 or more and 1 or less, more preferably 0.3 or more and 1 or less, still more preferably 0.5 or more and 1 or less, and particularly preferably 0.7 or more and 1 or less.

It is preferable that in the silsesquioxane derivative, a plurality of alkyl groups having different carbon numbers are randomly bonded to silicon atoms. Alkyl groups randomly bonding means that alkyl groups having different carbon numbers are randomly located, rather than a case where alkyl groups having different carbon numbers are located at specific silicon atoms (for example, only at adjacent silicon atoms). The random bonding of the alkyl groups having different carbon numbers can be confirmed by a combination of mass spectrometry and nuclear magnetic resonance measurement.

One or more of the plurality of alkyl groups may be substituted with a halogen atom (for example, fluorine), but the plurality of alkyl groups is preferably unsubstituted.

In the silsesquioxane derivative, a functional group or an atomic group other than the alkyl group may be bonded to one or more silicon atoms. The type of functional group or atomic group is not particularly limited, and may be as follows: a polymerizable group such as a (meth)acryloyl group, a vinyl group, an allyl group, an oxetanyl group, or an epoxy group, or an atomic group having such a polymerizable group; an atomic group having an amide group, an ester group, an ether group, or a urethane group; an aromatic group such as a phenyl group or an atomic group having the aromatic group; an amino group, a hydroxyl group, a mercapto group, or an atomic group having the amino group, hydroxyl group, or mercapto group; an atomic group having an ethylene oxide group or a propylene oxide group; a silanol group or an atomic group having the silanol group; a halogen atom such as a fluorine atom or an atomic group having the halogen atom; or the like. The number of silicon atoms to which a functional group or an atomic group other than the alkyl group is bonded is preferably less than half the number of silicon atoms contained in the silsesquioxane derivative, more preferably 3 or less, still more preferably 2 or less, even more preferably 1 or less, and particularly preferably 0. The silsesquioxane derivative may have a silicon atom that is not substituted with an alkyl group during synthesis and has a hydrogen atom bonded to it.

The silsesquioxane derivative can be synthesized by reacting a silsesquioxane which has a polyhedral structure and in which hydrogen atoms are bonded to all silicon atoms (hereinafter, referred to as “H-POSS”) with two types of alkenes having different carbon numbers. During the reaction, another compound for introducing the functional group or the atomic group may be used in combination as necessary.

Specifically, H—POSS and two or more types of alkenes having different carbon numbers are dissolved in a solvent such as toluene capable of dissolving these compounds. In this case, the number of equivalents of the alkenes is preferably 8 equivalents or more and 100 equivalents or less, and more preferably 8 equivalents or more and 10 equivalents or less with respect to the equivalent of H-POSS.

Next, a Karstedt catalyst or a Speier's catalyst (H₂PtCl₆) is added to the solution obtained above, and the mixture is heated to 60 °C to 110 °C in an inert atmosphere such as nitrogen or argon. The heating time is not particularly limited, but can be set to 5 hours or more and 24 hours or less. For bonding an alkyl group having a small number of carbon atoms to a silicon atom, heating may be performed in a gaseous atmosphere such as ethylene, propylene, or butene (in this case, one type of alkene may be dissolved in the above-described solution, or two or more types of alkenes may be dissolved in the above-described solution).

Thereafter, the synthesized silsesquioxane derivative is extracted by cooling the resultant to room temperature. The extraction can be performed by silica column chromatography using hexane as an eluent, but other methods may be appropriately used. After the extraction, removal of unreacted alkene and/or by-product alkanes, purification of the silsesquioxane derivative, or the like may be performed as necessary.

### [Coating Composition, Method for Producing Coated Article, and Coated Article]

The coating composition contains the above-described silsesquioxane derivative and a solvent for dissolving the silsesquioxane derivative.

The solvent is not particularly limited, and at least one of the following can be used: water; halogen-based solvents such as dichloromethane, chloroform, carbon tetrachloride, 1,2-dichloroethane, perchloroethylene, ethylene chloride, chlorobenzene, trichloromethane, and tetrachloromethane; hydrocarbon solvents such as propane, butane, pentane, hexane, heptane, octane, decane, dodecane, cyclopentane, cyclohexane, methylcyclopentane, methylcyclohexane, benzene, toluene, and xylene; ether-based solvents such as tetrahydrofuran, diethyl ether, and dibutyl ether; ester-based solvents such as propylene glycol monomethyl ether acetate, ethyl acetate, and butyl acetate; ketone-based solvents such as acetone, methyl ethyl ketone, and methyl isobutyl ketone; alcohols such as methanol, ethanol, isopropyl alcohol, isobutyl alcohol, ethylene glycol; and other solvents such as glycerin, propylene glycol monomethyl ether, N-methylpyrrolidone, dimethylformamide, and dimethyl sulfoxide. Among these, chloroform is preferable as a solvent because it provides satisfactory solubility for the silsesquioxane derivative and enables a uniform surface coating.

The concentration of the silsesquioxane derivative in the coating composition is not particularly limited, and can be set to 1% by mass or more and 20% by mass or less based on the total mass of the coating composition. From the viewpoint of forming a uniform and sufficiently thick coating, the concentration can be set to 3% by mass or more and 15% by mass or less, and is preferably 5% by mass or more and 10% by mass or less.

A silsesquioxane derivative having a single type of alkyl group had extremely low solubility in chloroform, but the silsesquioxane derivative having a plurality of alkyl groups having different carbon numbers can be dissolved in chloroform even to a concentration of 10% by mass or more.

The coating composition may contain, in addition to the silsesquioxane derivative, an additional additive such as a monomer (polymerizable compound), a polymerization initiator, a polymerization inhibitor, a resin, any curing agent for the resin, an antioxidant, a ultraviolet absorber, a leveling agent, a filler, metal fine particles, and/or a pigment. Only the silsesquioxane derivative is necessary for the coating composition to form a film, so that the additional additive such as a monomer, a resin, and a polymerization initiator and a curing agent for the resin does not have to be added. For example, the concentration of the monomer and/or the resin can be set to 0% by mass or more and 10% by mass or less, preferably 0% by mass or more and 5% by mass or less, and more preferably 0% by mass or more and 1% by mass or less based on the total mass of the solids in the coating composition.

The coating composition can be used to form a coating by applying the coating composition to a base material and removing the solvent as necessary.

The base material may be any base material of various types such as a polymeric resin (such as a polyimide film), silicon, glass, and a metal such as aluminum. These base materials may be subjected to pretreatment such as washing and ozone treatment as necessary. According to the findings of the present inventors, a film with satisfactory properties can be formed on a base material made of a resin such as a polyimide without pretreatment.

The application method is not particularly limited, and various methods such as a roll coating method, a spin coating method, a spray coating method, an immersion method, a screen printing method, and an ink jet method can be used.

After the application of the coating composition, the solvent may be optionally removed by any method such as heating. The method of removing the solvent can be appropriately selected depending on the type of solvent used. In addition, when the solvent can be removed during the application, such as when the coating composition is applied to a base material by a spin coating method, the removal of the solvent is not necessary.

The thickness of the coating is not particularly limited, which can be set according to the application. For example, the thickness of the coating is preferably 50 nm or more and 2,500 nm or less, more preferably 100 nm or more and 2,000 nm or less, and still more preferably 200 nm or more and 1,500 nm or less.

The coating composition can form a smooth coating having a small height difference on the surface thereof. For example, the height difference on the surface of the coating formed from the coating composition can be 100 nm or less. The height difference is a value measured using a known contact-type step profilometer (for example, Alpha-Step IQ manufactured by KLA-Tencor Corporation).

In addition, the coating composition can form a coating having high transparency. The absorptance of the coating formed from the coating composition can be less than 0.05 for sunlight having a wavelength of 250 to 2,500 nm. The absorptance is a value measured using a known solar absorptance measuring apparatus (for example, a spectrophotometer U-4100, manufactured by Hitachi High-Tech Corporation, equipped with a Spectralon integrating sphere).

The coating formed in this manner has the same composition as the coating composition, except for the volatile components such as the solvent. For example, the concentration of the resin component in the coating is the same as the concentration of the monomer and the resin based on the total mass of the solids in the coating composition.

### [Application]

The coated articles thus produced, in which the coating is formed on the surface of the base material, can be used for various applications, such as spacecraft members, members for mobile equipment such as automobiles, trucks, trains, ships, and airplanes, exteriors of houses, electronic members, electrical members, optical members, and medical members. Specifically, the coated article may be a coated article in which the coating is formed on the outer surface of a solar cell apparatus, an electric wire, an antenna, a thermal control material sheet, or a thermal insulating film. When the coated article is used as a member of spacecraft, the coated article is used as a member disposed on the spacecraft surface that is exposed to the outside of the spacecraft body, and by disposing the coating to face the outside of the spacecraft body, the silsesquioxane derivative can impart high AO resistance to the member. These coated articles may be used in outer space, may be used on the ground, or may be used on a planet or a satellite other than the Earth, such as the surface of the Moon, Mars, or an asteroid.

Furthermore, in addition to the coating composition, the silsesquioxane derivative can also be used as a heat resistance imparting agent, a flame retardant, a wear resistance imparting agent, a crosslinking agent, a viscosity adjuster, a binder resin, or the like.

### OTHER EMBODIMENTS

The above-described embodiment is an exemplary embodiment of the present invention, and it will be apparent that the present invention may be embodied in other specific forms without departing from its essential characteristics.

### EXAMPLES

The present invention will be described in detail based on examples, but the present invention is not limited to these examples.

### 1. Synthesis of Silsesquioxane Derivative

### 1-1. Synthesis of C₈C₁₀C₁₂C₁₄-POSS

H-POSS having eight Si atoms (a compound having a structure shown in general formula (1) where all R's are hydrogen atoms: 85 mg, 0.20 mmol), 1-octene (49 mg, 0.44 mmol), 1-decene (62 mg, 0.44 mmol), 1-dodecene (74 mg, 0.44 mmol), and 1-tetradecene (86 mg, 0.44 mmol) were placed in a screw tube, and the mixture was dissolved in 2 mL of toluene. Thereafter, 120 μL of a Karstedt catalyst (to 2% in xylene) was added to the resultant, and the mixture was heated overnight at 80 °C under a nitrogen atmosphere. After the reaction, the mixture was cooled to room temperature, and the generated compound group was eluted using silica column chromatography (eluent: hexane). The solution containing the target substance was concentrated under reduced pressure, and the starting alkenes and by-product alkanes were distilled off under reduced pressure (125 °C, 5 Torr) using a Kugelrohr apparatus. The compound was purified using the silica column chromatography (eluent: hexane) again, and the solvent was distilled off under reduced pressure to obtain 180 mg of the target substance as a white solid.

¹H NMR (400 MHZ, CDCl₃): δ 1.46-1.26 (m, 150H), 0.88 (t, J=6.8 Hz, 24H), 0.60 (t, J=8.4 Hz, 16H)

### 1-2. Synthesis of C₈C₁₆-POSS

H-POSS (85 mg, 0.20 mmol), 1-octene (99 mg, 0.88 mmol), and 1-hexadecene (198 mg, 0.88 mmol) were placed in a screw tube, and the mixture was dissolved in 2 mL of toluene. Thereafter, 120 μL of a Karstedt catalyst (to 2% in xylene) was added to the resultant, and the mixture was heated overnight at 80 °C under a nitrogen atmosphere. After the reaction, the mixture was cooled to room temperature, and the generated compound group was eluted using silica column chromatography (eluent: hexane). The solution containing the target substance was concentrated under reduced pressure, and the starting alkenes and by-product alkanes were distilled off under reduced pressure (125 °C, 5 Torr) using a Kugelrohr apparatus. The compound was purified using the silica column chromatography (eluent: hexane) again, and the solvent was distilled off under reduced pressure to obtain 206 mg of the target substance as a white solid.

¹H NMR (400 MHZ, CDCl₃): δ 1.43-1.25 (m, 154H), 0.88 (t, J=7.2 Hz, 24H), 0.60 (t, J=8.0 Hz, 16H)

### 1-3. Synthesis of C₈C₁₂C₁₆-POSS

H-POSS (85 mg, 0.20 mmol), 1-octene (67 mg, 0.60 mmol), 1-dodecene (100 mg, 0.60 mmol), and 1-hexadecene (135 mg, 0.60 mmol) were placed in a screw tube, and the mixture was dissolved in 2 mL of toluene. Thereafter, 120 μL of a Karstedt catalyst (to 2% in xylene) was added to the resultant, and the mixture was heated overnight at 80 °C under a nitrogen atmosphere. After the reaction, the mixture was cooled to room temperature, and the generated compound group was eluted using silica column chromatography (eluent: hexane). The solution containing the target substance was concentrated under reduced pressure, and the starting alkenes and by-product alkanes were distilled off under reduced pressure (125 °C, 5 Torr) using a Kugelrohr apparatus. The compound was purified using the silica column chromatography (eluent: hexane) again, and the solvent was distilled off under reduced pressure to obtain 222 mg of the target substance as a white solid.

¹H NMR (400 MHZ, CDCl₃): δ 1.46-1.25 (m, 156H), 0.88 (t, J=6.8 Hz, 24H), 0.60 (t, J=8.0 Hz, 16H)

### 1-4. Synthesis of C₆C₁₆-POSS

H-POSS (85 mg, 0.20 mmol), cyclohexene (72 mg, 0.88 mmol), and 1-hexadecene (197 mg, 0.88 mmol) were placed in a screw tube, and the mixture was dissolved in 2 mL of toluene. Thereafter, 120 μL of a Karstedt catalyst (to 2% in xylene) was added to the resultant, and the mixture was heated overnight at 75 °C under a nitrogen atmosphere. After the reaction, the mixture was cooled to room temperature, and the generated compound group was eluted using silica column chromatography (eluent: hexane). The solution containing the target substance was concentrated under reduced pressure, and the starting alkenes and by-product alkanes were distilled off under reduced pressure (125 °C, 5 Torr) using a Kugelrohr apparatus. The compound was purified using the silica column chromatography (eluent: hexane) again, and the solvent was distilled off under reduced pressure to obtain 157 mg of the target substance as a white solid.

¹H NMR (400 MHZ, CDCl₃): δ 1.82-1.62 (m, 5H), 1.46-1.18 (m, 201H), 0.87 (t, J=6.4 Hz, 21H), 0.78-0.69 (m, 1H), 0.67-0.53 (m, 14H)

### 1-5. Synthesis of C₂C₁₆-POSS

H-POSS (85 mg, 0.20 mmol) and 1-hexadecene (198 mg, 0.88 mmol) were placed in a small autoclave, and the mixture was dissolved in 2 mL of toluene. Thereafter, 120 μL of a Karstedt catalyst (to 2% in xylene) was added to the resultant, and the mixture was heated overnight at 80 °C under ethylene gas pressure. After the reaction, the mixture was cooled to room temperature, and the generated compound group was eluted using silica column chromatography (eluent: hexane). The solution containing the target substance was concentrated under reduced pressure, and the starting alkene and by-product alkanes were distilled off under reduced pressure (125 °C, 5 Torr) using a Kugelrohr apparatus. The compound was purified using the silica column chromatography (eluent: hexane) again, and the solvent was distilled off under reduced pressure to obtain the target substance as a white solid.

### 1-6. Synthesis of C₈-POSS

H-POSS (100 mg, 0.24 mmol) and 1-octene (0.33 mL, 2.1 mmol) were placed in a screw tube, and the mixture was dissolved in 2 mL of toluene. Thereafter, 140 μL of a Karstedt catalyst (to 2% in xylene) was added to the resultant, and the mixture was heated overnight at 80 °C under a nitrogen atmosphere. After the reaction, the mixture was cooled to room temperature and concentrated under reduced pressure. The compound was purified using silica column chromatography (eluent: hexane), and the solvent was distilled off under reduced pressure to obtain 187 mg of the target substance as a white solid.

¹H NMR (400 MHZ, CDCl₃): δ 1.42-1.26 (m, 96H), 0.88 (t, J=6.8 Hz, 24H), 0.60 (t, J=8.0 Hz, 16H)

### 1-7. Synthesis of C₁₆-POSS

H-POSS (100 mg, 0.24 mmol) and 1-hexadecene (450 mg, 2.0 mmol) were placed in a screw tube, and the mixture was dissolved in 2 mL of toluene. Thereafter, 140 μL of a Karstedt catalyst (to 2% in xylene) was added to the resultant, and the mixture was heated overnight at 80 °C under a nitrogen atmosphere. After the reaction, the mixture was cooled to room temperature and concentrated under reduced pressure. The compound was purified using silica column chromatography (eluent: hexane), and the solvent was distilled off under reduced pressure. Further, the target substance was obtained as 257 mg of a white solid by recrystallization using hexane.

¹H NMR (400 MHZ, CDCl₃): δ 1.43-1.25 (m, 224H), 0.88 (t, J=6.8 Hz, 24H), 0.60 (t, J=8.0 Hz, 16H)

### 2. Evaluation-1 (Film Forming Properties)

The following evaluations were performed using four types of POSS derivatives, namely C₈C₁₀C₁₂C₁₄-POSS, C₈C₁₆-POSS, C₈-POSS, and C₁₆-POSS.

### 2-1. Solubility in Organic Solvent

The four types of POSS derivatives were each dissolved in hexane and chloroform at room temperature to have a concentration of 10% by mass. When sufficient solubility was not observed, whether the dissolution occurred or not was confirmed by raising the temperature to 60 °C.

Based on these results, the solubility was evaluated according to the following criteria.

∘: The POSS derivative was sufficiently dissolved in all of hexane, tetrahydrofuran, and chloroform at room temperature, and a solution having a concentration of 5% by mass or more could be prepared.

x: A solution having a concentration of 5% by mass or more could not be prepared in chloroform, tetrahydrofuran, and hexane at room temperature, but a solution having a concentration of 5% by mass or more could be prepared by raising the temperature.

### 2-2. Wettability on Base Material Surface

The chloroform solutions (concentration: 10% by mass) of C₈C₁₀C₁₂C₁₄-POSS and C₈C₁₆-POSS, and the tetrahydrofuran solutions (concentration: 2.5% by mass) of C₈-POSS and C₁₆-POSS were filtered through a filter. As a base material, the following were prepared: a silicon substrate which had been washed with toluene, acetone, water, and 2-propanol, dried, and subjected to an ozone treatment to remove dirt on the surface; and a polyimide film which had not been subjected to pretreatment. Then, 20 to 100 μL of each filtered solution was used to form films on the surfaces of the silicon substrates and the polyimide films using a spin coater (MS-A100, manufactured by MISAKA Co., Ltd.) at 4,000 rpm for the chloroform solutions of C₈C₁₀C₁₂C₁₄-POSS and C₈C₁₆-POSS and at 1,500 rpm for the tetrahydrofuran solutions of C₈-POSS and C₁₆-POSS.

However, when the tetrahydrofuran solutions of C₈-POSS and C₁₆-POSS were used, a film having a sufficient thickness (100 nm or more) could not be formed. Therefore, hexane solutions of the C₈-POSS and C₁₆-POSS (dissolved at 60 °C, concentration: 10% by mass) were added dropwise to the silicon substrate heated to 50 °C and spin-coated at 4,500 rpm.

The formed films were observed, and the wettability was evaluated according to the following criteria.
∘: For all of the solutions, a film could be formed on both the silicon substrate and the polyimide film at room temperature without exposing the base material
Δ: When a film was formed at room temperature using a low concentration solution having a concentration of 5% by mass or less, a film in which the base material was exposed was formed, but a film having a sufficient thickness could be formed without exposing the base material by using a high concentration solution having a concentration of 5% by mass or more, which was created by raising the temperature to 50 °C or higher
x: For none of the solutions, a film having a sufficient thickness could not be formed, and a part of the base material was exposed

### 2-3. Uniformity of Film

In the wettability test on the base material surface, the surface unevenness of the films formed using the chloroform solutions of C₈C₁₀C₁₂C₁₄-POSS and C₈C₁₆-POSS and the films formed using the hexane solution of C₁₆-POSS was measured using a contact-type step profilometer (Alpha-Step IQ, manufactured by KLA-Tencor Corporation).

The uniformity of the film was evaluated according to the following criteria based on the measured height difference of the surface unevenness.
∘: The height difference of the surface unevenness was less than 100 nm
x: The height difference of the surface unevenness was 100 nm or more

The evaluation results are shown in Table 1.

TABLE 1

| | Solubility | Wettability | Uniformity |
|---|---|---|---|
| C₈C₁₀C₁₂C₁₄-POSS | ∘ | ∘ | ∘ |
| C₈C₁₆-POSS | ∘ | ∘ | ∘ |
| C₈-POSS | ∘ | x | x |
| C₁₆-POSS | x | Δ | x |

As shown in Table 1, the POSS derivatives having a plurality of alkyl groups having different carbon numbers had satisfactory solubility in a general-purpose organic solvent, wettability on the base material, and uniformity of the film.

The thicknesses of the films formed using the chloroform solutions of C₈C₁₀C₁₂C₁₄-POSS and C₈C₁₆-POSS were 400 to 1,000 nm, and the height differences of the surface unevenness were several tens of nm. In addition, the thickness of the film formed using the tetrahydrofuran solution of C₈-POSS was several tens of nm, and the base material was exposed, so that the height difference of the surface unevenness could not be measured. In addition, the thickness of the film formed using the hexane solution of C₁₆-POSS was 1,000 to 2,000 nm, and the height difference of the surface unevenness was 500 to 1,000 nm. It was found that a POSS derivative having a plurality of alkyl groups having different carbon numbers could form a film having satisfactory properties.

### 3. Evaluation-2 (Transparency and AO Resistance)

The following evaluations were performed using a test piece in which a film (thickness: 1 μm) was formed on the surface of the polyimide film using each of the chloroform solutions of C₈C₁₀C₁₂C₁₄-POSS and C₈C₁₆-POSS.

### 3-1. Transparency

Using a solar absorptance measuring apparatus (a spectrophotometer U-4100 manufactured by Hitachi High-Tech Corporation, equipped with a Spectralon integrating sphere), the solar absorptance of the polyimide film before the film formation and the solar absorptance of the film formed surface of the test piece (i.e., surface of the test piece where the film is formed) were measured.

### Measurement Conditions:

Measurement wavelength: 250 to 2,500 nm
Scanning width: 1 nm
Detector: photomultiplier tube/lead sulfide element

The solar absorptance of the polyimide film before the film formation was subtracted from the solar absorptance of the film formed surface, and the transparency of the formed film was evaluated according to the following criteria based on the obtained calculation results.
∘: The difference in the solar absorptance was less than 0.05
x: The difference in the solar absorptance was 0.05 or more

### 3-2. AO Resistance (Mass Reduction)

The film formed surface of the test piece was irradiated with atomic oxygen (AO) under the following conditions.

### Irradiation Conditions:

AO velocity: 8 km/s
Irradiation time: 41 hours
Average AO flux: 4.2×10¹⁵ atoms·cm⁻²·s⁻¹
Irradiation amount: 6×10²⁰ atoms·cm⁻²
Irradiation area: 3.14 cm²
Irradiation temperature: room temperature
Irradiation vacuum degree: approximately 2× 10⁻² Pa

The test piece before the AO irradiation and the test piece after the AO irradiation were allowed to stand in an environment of a temperature of 23±3 °C and a relative humidity of 50±5% for 6 hours or more. Thereafter, the mass of each test piece was measured by an electronic balance (microbalance XP6, manufactured by Mettler Toledo) capable of measuring to the μg unit.

The AO irradiation and mass measurement were performed on three test pieces, and the mass after the AO irradiation was subtracted from the mass before the AO irradiation for each test piece, and the subtraction amount (mg) was divided by the area (mm²) of the test piece. The AO resistance (mass reduction) of the film was evaluated according to the following criteria based on the obtained calculation results.
∘: The mass reduction was less than 2×10⁻⁴ mg/mm²
x: The mass reduction was 2×10⁻⁴ mg/mm² or more

### 3-3. AO Resistance (Crack Resistance)

The surface of each test piece irradiated with AO in the AO resistance evaluation (mass reduction) was observed with a scanning electron microscope (JSM-7900F, manufactured by JEOL Ltd.). The AO resistance (crack resistance) of the film was evaluated according to the following criteria based on the observation results.
∘: There was no defect (crack) having a width of 1 μm or more on the surface of the film
x: There was a defect (crack) having a width of 1 μm or more on the surface of the film

### 3-4. AO Resistance (Change in Transparency)

Using a solar absorptance measuring apparatus (a spectrophotometer U-4100 manufactured by Hitachi High-Tech Corporation, equipped with a Spectralon integrating sphere), the solar absorptance of the surface of each test piece irradiated with AO in the AO resistance evaluation (mass reduction) and the solar absorptance of the film formed surface of the test piece before the AO irradiation were measured.

### Measurement Conditions:

Measurement wavelength: 250 to 2,500 nm
Scanning width: 1 nm
Detector: photomultiplier tube/lead sulfide element

The solar absorptance of the film formed surface before the AO irradiation was subtracted from the solar absorptance of the film formed surface after the AO irradiation, and the transparency of the film was evaluated according to the following criteria based on the obtained calculation results.
∘: The difference in the solar absorptance was less than 0.05
x: The difference in the solar absorptance was 0.05 or more

The evaluation results are shown in Table 2.

TABLE 2

| | | | | AO resistance |
|---|---|---|---|---|
| | | AO resistance | AO resistance | (Change in |
| | Transparency | (Mass reduction) | (Crack resistance) | transparency) |
| C₈C₁₀C₁₂C₁₄-POSS | ∘ | ∘ | ∘ | ∘ |
| C₈C₁₆-POSS | ∘ | ∘ | ∘ | ∘ |

As shown in Table 2, the POSS derivative having a plurality of alkyl groups having different carbon numbers had satisfactory transparency and excellent AO resistance.

### 4. Evaluation-3 (Outgassing Properties)

The outgassing properties were evaluated using a test piece in which a film was formed on the surface of a polyimide film having a thickness of 25 μm, which was used as a base material, by a spin coating method using each of the chloroform solutions (concentration: 10% by mass) of C₈C₁₀C₁₂C₁₄-POSS and C₈C₁₆-POSS. The film thickness of the test piece used for the evaluation was 500 to 900 nm in the case of C&C₁₀C₁₂C₁₄-POSS and 300 to 500 nm in the case of C₈C₁₆-POSS.

The outgassing properties were measured under the following measurement conditions according to ASTM E595-93:1999.

### (Measurement Conditions)

Vacuum degree: 7×10⁻³ Pa or less
Material heating temperature: 125±1 °C.
Released gas cooling temperature: 24±1 °C.
Retention time: 24 hours
Measurement items: TML, CVCM, RML
Initial sample weight: 210 to 220 mg

The total mass loss (TML) was obtained by the following expression: {(sample weight before test−sample weight after test)/sample weight before test}×100. In addition, the collected volatile condensable material (CVCM) was obtained by the following expression: {(collector plate weight after test−collector plate weight before test)/collector plate weight before test}×100. In addition, the weight of the test piece after the test, which was stored at 23±1 °C/50% RH for 24 hours, was used as the sample weight after moisture absorption, and the ratio of water vapor regained (WVR) was obtained by the following expression: {(sample weight after moisture absorption−sample weight after test)/sample weight before test}×100. The recovered mass loss (RML) was obtained by (TML-WVR).

For each of TML, CVCM, and RML, the evaluation was determined as passed (o) when TML was 1% or less, CVCM was 0.1% or less, and RML was 1% or less, and the evaluation was determined as failed (x) in other cases.

The evaluation results are shown in Table 3.

TABLE 3

| | TML | CVCM | RML |
|---|---|---|---|
| Base material | ∘ | ∘ | ∘ |
| C₈C₁₀C₁₂C₁₄-POSS | ∘ | ∘ | ∘ |
| C₈C₁₆-POSS | ∘ | ∘ | ∘ |

As shown in Table 3, the POSS derivative having a plurality of alkyl groups having different carbon numbers had satisfactory outgassing properties and was suitable for use in space applications.

The present application claims the priority of Japanese Patent Application No. 2023-089767 filed on May 31, 2023. The matters described in the specification and the claims at the time of filing of the present application are incorporated in the present application by reference.

### INDUSTRIAL APPLICABILITY

The coating composition according to the present invention can be applied to various applications.

1. A coating composition, comprising:
a silsesquioxane derivative having a silsesquioxane skeleton with a polyhedral structure and having a plurality of alkyl groups having different carbon numbers, the plurality of alkyl groups each being bonded to a silicon atom.

2. The coating composition according to claim 1, wherein the coating composition is a coating composition of a spacecraft.

3. The coating composition according to claim 1, wherein
a concentration of a polymerizable compound and a resin in the coating composition is 0% by mass or more and 10% by mass or less based on a total mass of solids in the coating composition.

4. A method for producing a coated article, the method comprising:
applying the coating composition according to claim 1 to a base material.

5. A coated article, comprising:
a base material; and
a coating formed on a surface of the base material, the coating containing a silsesquioxane derivative that has a silsesquioxane skeleton with a polyhedral structure and has a plurality of alkyl groups having different carbon numbers, the plurality of alkyl groups each being bonded to a silicon atom.

6. The coated article according to claim 5, wherein
the coated article is a member disposed on a surface of a spacecraft, the surface being exposed to an outside of a body of the spacecraft.

7. A silsesquioxane derivative, comprising:
a silsesquioxane skeleton with a polyhedral structure; and
a plurality of alkyl groups having different carbon numbers, the plurality of alkyl groups each being bonded to a silicon atom.
